(19) United States
(12) Patent Application Publication
(10) Pub. No.: US 2006/0032470 A1
(43) Pub. Date: Feb. 16, 2006

(54) Device for igniting an internal combustion engine

(76) Inventor: Heiko Ridderbusch, Stuttgart-Moehringen (DE)

Correspondence Address: KENYON & KENYON, ONE BROADWAY, NEW YORK, NY, 10004, US

(21) Appl. No.: 11/155,134

(22) Filed: Jun. 16, 2005

(30) Foreign Application Priority Data
Aug. 14, 2004 (DE) 102004039466.0

(51) Int. Cl. F02P 23/04

(52) U.S. Cl. 123/143 B

(57) ABSTRACT

A device for ignition in an internal combustion engine using laser radiation. The laser radiation has a plurality of laser sub-beams that are focused at a plurality of different focus points in the combustion chamber.

### BACKGROUND INFORMATION

From German Patent Application No. DE 199 11 737, a device is known for igniting an internal combustion engine in which focused laser radiation is introduced into a combustion chamber of an internal combustion engine. Due to the strong focusing of the laser radiation, in this focus point a temperature results that is so high that the laser radiation causes an ignition of an air/fuel mixture in the combustion chamber.

### SUMMARY OF THE INVENTION

The device according to the present invention has the advantage that an ignition of the air/fuel mixture takes place at a plurality of points in the combustion chamber through the focusing of the laser beams. The plurality of ignition locations formed in this way improves the reliability of the ignition. An optimal ignition of the air/fuel mixture is not possible at every point in the combustion chamber in all operating states. This fact is counteracted by the spatial distribution of the various ignition locations. In addition, the provision of a plurality of ignition locations generally improves the ignition. Because the paths traveled by the flame front in the combustion chamber are also reduced, the tendency to knock can be significantly reduced. In addition, the plurality of ignition locations shortens the time required for the combustion of the mixture in the combustion chamber, which is advantageous from a thermodynamic point of view.

The plurality of laser sub-beams is produced in a particularly simple fashion by dividing the light from a laser source into a plurality of laser sub-beams. For this purpose, it makes sense to use a lens array or a holographic element, which respectively divides or focuses a laser beam onto a plurality of points in the combustion chamber. Alternatively, or also additionally, a plurality of laser sources can also be provided.

### BRIEF DESCRIPTION OF THE DRAWINGS

FIGS. 1, 2 and 3 each show a combustion chamber of an internal combustion engine, containing laser beams that have been introduced.

### DETAILED DESCRIPTION

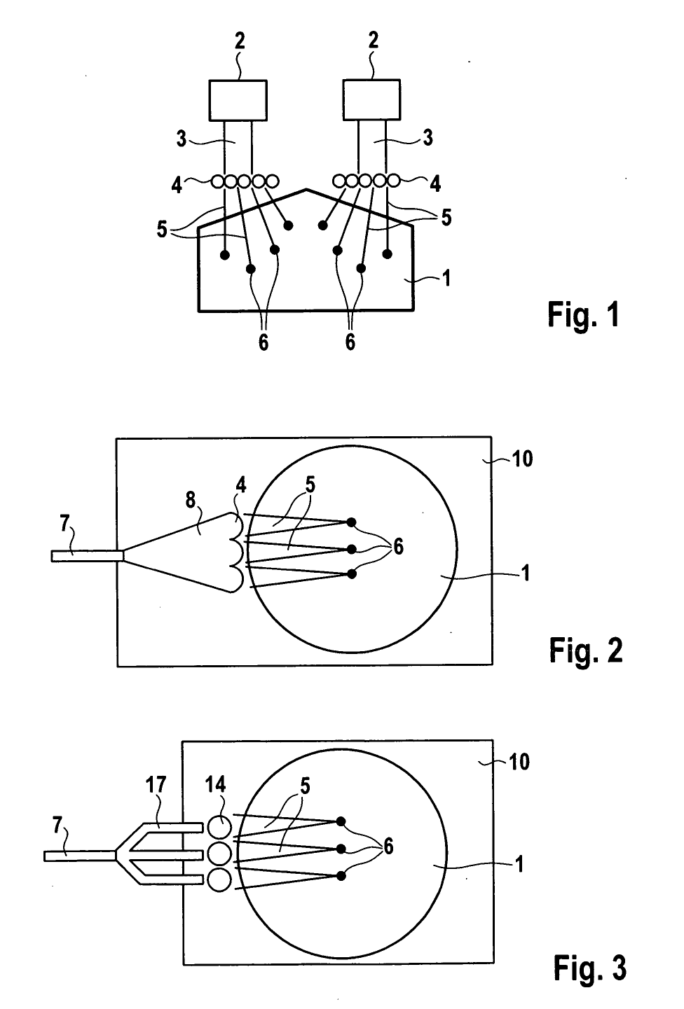

In FIG. 1, the combustion chamber of an internal combustion engine is schematically designated 1. Such a combustion chamber is the standard combustion chamber of an SI engine as standardly used in today's motor vehicles. Because the details of such engines are generally known, here combustion chamber 1 is indicated only schematically as a closed volume, without indicating further details.

In order to ignite the air/fuel mixture that has been brought into combustion chamber 1, two laser sources 2 are provided that emit laser radiation 3. Laser radiation 3 is sent through a lens array 4. This divides laser radiation 3 into a plurality of laser sub-beams 5, each of which then focuses in a focus point 6. Focus points 6 are situated in the interior of combustion chamber 1, and are used to ignite the air/fuel mixture in combustion chamber 1. In focus points 6, each of the laser sub-beams 5 is focused onto a very small point, which greatly increases the temperature at this point. The focusing here is so strong that laser sub-beams 5 produce in focus points 6 a temperature that is sufficiently high to effect an ignition of the air/fuel mixture in combustion chamber 1. Starting from these focus points 6, the air/fuel mixture in combustion chamber 1 then burns. A traveling flame front begins at focus points 6.

The plurality of focus points 6 achieves various advantages. Because a plurality of focus points 6 is provided, the air/fuel mixture is ignited simultaneously at a plurality of locations in the combustion chamber, which increases the reliability of the ignition. Here, dependent on the operating state of the internal combustion engine, the probability of an ignition of the air/fuel mixture is not equally high at each of focus points 6. However, because a multiplicity of focus points 6 is provided, good conditions for an ignition of the air/fuel mixture will be present at at least one of these focus points. Normally, an ignition of the air/fuel mixture will occur at a plurality of focus points 6. This has the advantage that in order to burn the entire air/fuel mixture in combustion chamber 1 the flame front does not have to travel any long paths, thus reducing the burning duration. This is advantageous from a thermodynamic point of view. In addition, the ignition can also take place shortly after the upper ignition point, which increases the efficiency of the internal combustion engine. In addition, the ignition at several locations reduces the tendency to knock of the internal combustion engine, so that the engine efficiency can be improved, for example by increasing the compression. In addition, due to the plurality of ignition locations the combustion temperature is lowered, which can result in a reduction of the NOx content of the exhaust gas.

FIG. 2 shows a top view of an engine block 10. In engine block 10 there is situated a cylinder that has in particular a combustion chamber 1 that is round when viewed from above. The placement of a cylinder head onto engine block 10 seals combustion chamber 1. The cylinder head is not shown in this top view of engine block 10. Around combustion chamber 1 there is situated, in the standard manner, a seal that seals combustion chamber 1 against the surrounding environment. This seal is also not shown here. On the upper side of engine block 10 there is situated an optical waveguide 8 that is so flat that it can also be placed in the seal between engine block 10 and the cylinder head. Through an optical (or glass) fiber 7, laser radiation is coupled in at an outer end of optical waveguide 8. Inside optical waveguide 8, this laser radiation is conducted so that it exits at the opposite side of optical waveguide 8, which extends up to combustion chamber 1. This exit side of optical waveguide 8 is fashioned as a lens array 4, and correspondingly, again, produces a plurality of laser sub-beams 5 that focus at corresponding focus points 6. At these focus points 6, the temperature is increased so strongly that an air/fuel mixture can be ignited there. Light-conducting element 8 can for example be made of glass. Through such a very flat optical waveguide 8, in this way laser radiation can be brought into combustion chamber 1 of the internal combustion engine in the area of the cylinder head seal. Due to the very thin construction of this optical waveguide 8, the sealing effect of the cylinder head seal is not adversely affected here. Such cylinder head seals are sometimes also made of materials that are pasty at first and then harden to form a sealing compound. The device shown in FIG. 2 thus uses an idea similar to that in German Patent Application No. DE 199 11 737; in the present invention, however, it is not the case that only a single optical fiber is situated in the area of the cylinder head seal; rather, an optical waveguide 8 is situated there that additionally divides the laser radiation into a plurality of laser sub-beams 5.

Besides the lens array shown in FIG. 1, or the construction shown in FIG. 2 of an optical waveguide 8 at one side as a lens-array-type structure 4, corresponding holographic structures, i.e. diffraction structures, can also be used. Such diffraction structures can also be used to focus the laser beams passing through them onto focus points 6.

FIG. 3 shows another specific embodiment of the present invention. Again, a top view of an engine block 10 containing a combustion chamber 1 is shown. Laser radiation is fed in through an optical fiber 7. Outside the engine block, the laser radiation from optical fiber 7 is divided among a plurality of additional optical fibers 17. This takes place either using a corresponding beam splitter or by splicing additional optical fibers 17 with optical fiber 7 in such a way that the laser radiation is divided among the additional optical fibers 17. These additional optical fibers 17 then end at individual spherical lenses 14 that are situated at the edge of combustion chamber 1 of the internal combustion engine. Spherical lenses 14 then focus the laser radiation from the individual additional optical fibers 17 to form focused laser sub-beams 5 that are then merged at focus points 6. The routing of the individual optical fibers 17 through the area of the seal between engine block 10 and the cylinder head (not shown here) then corresponds to the design described in German Patent Application No. DE 199 11 737. An advantage of the present system is that the division among a plurality of optical fibers 17 takes place outside the area of engine block 10, which facilitates the routing through the cylinder head seal. In addition, the division among individual optical fibers outside the engine is easier, and the connection point is also subsequently accessible for the correction of errors that may occur.

What is claimed is:

1. A device for igniting an internal combustion engine in which focused laser radiation is brought into a combustion chamber of the internal combustion engine in order to ignite an air/fuel mixture, the device comprising:
an arrangement for focusing a plurality of laser sub-beams of the laser radiation on various focus points of the combustion chamber.

2. The device according to claim 1, further comprising a laser source whose laser radiation is divided into a plurality of laser sub-beams.

3. The device according to claim 2, further comprising a lens array for the division that focuses the laser radiation onto a plurality of focus points.

4. The device according to claim 2, further comprising a holographic element for the division that focuses the laser radiation onto a plurality of focus points.

5. The device according to claim 1, further comprising:
an optical fiber; and
an optical waveguide situated between an engine block and a cylinder head of the internal combustion engine to which laser radiation is supplied at one side through the optical fiber, the optical waveguide being formed at a side facing the combustion chamber as one of a lens array and a holographic element.

6. The device according to claim 1, further comprising, situated between an engine block and a cylinder head, a plurality of optical fibers through which a plurality of laser sub-beams are brought into the combustion chamber.

7. The device according to claim 1, further comprising a plurality of laser sources whose light is respectively focused at various focus points in the combustion chamber.
